(19) United States
(12) Patent Application Publication
(10) Pub. No.: US 2025/0168254 A1
(43) Pub. Date: May 22, 2025

(54) System and Method for Buffering Sensor Data

(71) Applicant: ZEBRA TECHNOLOGIES CORPORATION, Lincolnshire, IL (US)

(72) Inventors: Charles Burton Swope, Coral Springs, FL (US); Stanko Jelavic, Davie, FL (US)

(21) Appl. No.: 18/518,263

(22) Filed: Nov. 22, 2023

(51) Int. Cl. H04L 67/568; H04L 67/12

(52) U.S. Cl. CPC H04L 67/568; H04L 67/12

(57) ABSTRACT

A controller includes: a communications interface to communicate with a set of sensors; a memory including a buffer to store buffered data; wherein the controller is configured to: receive, from a server, a first data request; in response to the first data request, send the buffered data in the buffer, the buffered data including first sensor data from the sensors in the set; obtain, from at least one given sensor in the set, second sensor data detected at the least one given sensor in the set; update the buffered data in the buffer to include second sensor data for the at least one given sensor; receive a second data request; and send to the server the buffered data in the buffer, the buffered data including the second sensor data for the at least one given sensor and the first sensor data for a remainder of the sensors in the set.

### BACKGROUND

Devices enabled with inter-integrated circuits (I2C) communications are convenient for their low cost and simplicity. However, I2C communications generally occur serially, and so querying a large I2C system may be long and time-consuming and may be problematic for substantially real-time operations.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for buffering sensor data for responding to data requests in substantially real-time.

FIG. 2 is a diagram of certain components of the system of FIG. 1.

FIG. 3 is a flowchart of a method for enabling sensors with unique addresses.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a controller comprising: a communications interface to communicate with a set of sensors; a memory including a buffer to store buffered data; wherein the controller is configured to: receive, from a server, a first data request; in response to the first data request, send to the server the buffered data in the buffer, the buffered data including first sensor data from the sensors in the set; obtain, from at least one given sensor in the set, second sensor data detected at the least one given sensor in the set; update the buffered data in the buffer to include second sensor data for the at least one given sensor; receive, from the server, a second data request; and in response to the second data request, send to the server the buffered data in the buffer, the buffered data including the second sensor data for the at least one given sensor and the first sensor data for a remainder of the sensors in the set.

Additional examples disclosed herein are directed to a method comprising: storing buffered data in a buffer; receiving, from a server, a first data request; in response to the first data request, sending to the server, the buffered data in the buffer, the buffered data including first sensor data from a set of sensors; obtaining, from at least one given sensor in the set, second sensor data detected at the at least one given sensor; updating the buffered data in the buffer to include the second sensor data for the at least one given sensor; receiving, from the server, a second data request; and in response to the data request, sending the buffered data to the server, the buffered data including the second sensor data for the at least one given sensor and the first sensor data for a remainder of the sensors in the set.

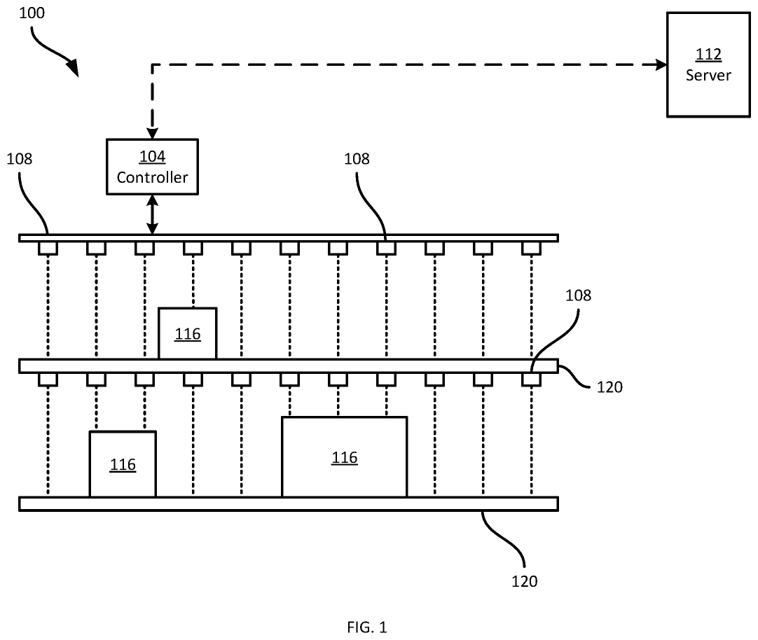

FIG. 1 depicts a system 100 for scanning a set of sensors in accordance with the teachings of this disclosure. The system 100 includes a controller 104 interconnected with a set of sensors 108. In some examples, the controller 104 may additionally be in communication with a server 112 via a communication link, illustrated in the present example as including wireless links. For example, the link may be provided by a wireless local area network (WLAN) deployed by one or more access points (not shown). In other examples, the server 112 is located remotely from the controller 104 and the link may therefore include one or more wide-area networks such as the Internet, mobile networks, and the like.

In the present example, the sensors 108 are proximity laser sensors configured to emit laser beams. In particular, the sensors 108 are configured as a laser curtain to detect items 116 (e.g., packages or the like) placed on a support surface such as a shelf 120. For example, the sensors 108 may be spaced at predefined intervals (e.g. 4-12 inches apart) based on the types of items 116 expected on the shelf 120. In particular, when an item 116 is placed on the shelf 120, one or more laser proximity sensors 108 may detect a change in proximity (i.e., from the distance between the sensors 108 and the shelf 120 to the distance between the sensors 108 and the item 116 on the shelf 120). In other examples, other proximity sensors or other suitable types of sensors may also be employed. The system 100 may be deployed, for example in a transport and logistics facility, such as a warehouse or the like, in a transport vehicle, such as a delivery truck, or other suitable environments. In other examples, the sensors 108 may also be employed in other arrangements or configurations, according to the application of the sensors 108 in the environment.

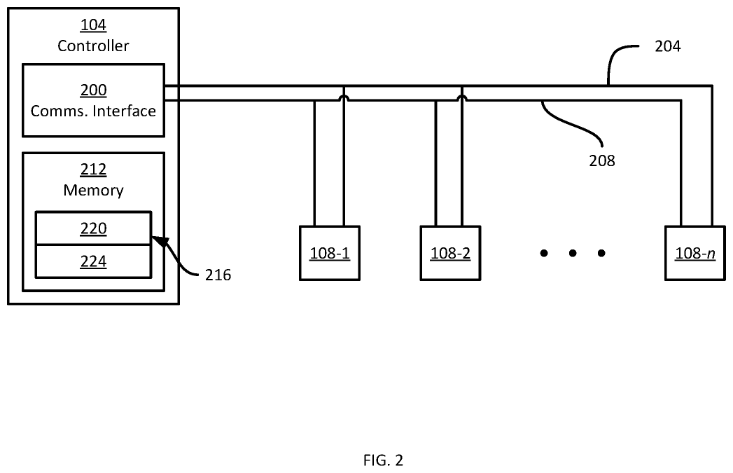

For example, with reference to FIG. 2, certain components of the system 100 are depicted in greater detail. In particular, FIG. 2 illustrates three exemplary sensors 108-1, 108-2, and 108-n of the set of sensors 108 (i.e., referred to generically as a sensor 108 and collectively as the sensors 108; this nomenclature is also used elsewhere herein). In some examples, the sensors 108 may be configured for I2C communications to the controller 104. Preferably the sensors 108 may be configured with programmable addresses. That is, the sensors 108 may accept an assignment of a custom address to allow the controller 104 to uniquely poll and/or scan the set of sensors 108. In some examples, each of the sensors 108 may be paired with a microcontroller (not shown) configured to cooperate with the controller 104 to assign each sensor 108 a unique address.

Accordingly, the controller 104 includes a communications interface 200 configured for I2C communications. For example, the communications interface 200 may utilize a 4-wire configuration and include suitable pins and the like to connect to each of the sensors 108 via a data line 204 and a clock line 208. In particular, when the controller 104 communicates to the sensors 108 via I2C communications, the controller 104 may send signals (i.e., a sequence of bits) via the data line 204 and the clock line 208 (e.g., to modify the signal for context or the like). For example, the data line 204 may be a serial data line (SDA), while the clock line 208 may be a serial clock line (SCL). Additionally, the controller 104 may cooperate with an I2C address bus to communicate with individual sensors 108.

The controller 104 may further be configured to communicate with the server 112 or another remote computing device. Accordingly, the communications interface 200 may further include suitable hardware (e.g., transmitters, receivers, network interface controllers, and the like) allowing the controller 104 to communicate with the server 112. The specific components of the communications interface 200 are selected based on the type of network or other links that the controller 104 utilizes to communicate over. In some examples, the controller 104 may include or be interconnected with a communications interface separate from the communications interface 200 allowing the controller 104 to communicate with the server 112.

The controller 104 may be any suitable processor, microcontroller, microprocessor, processing core, combinations of the above, and the like. The controller 104 may cooperate with a memory 212 storing machine-readable instructions which when executed cause the controller 104 to realize the functionality described herein. Some or all of the memory 212 may be integrated with the controller 104. The controller 104 and the memory 212 may comprise one or more integrated circuits. For example, the controller 104 may be an Arduino Nano or other similar controller.

The memory 212 may be a non-transitory computer-readable medium and may include a combination of volatile memory and non-volatile memory. The memory 212 may comprise one or more integrated circuits. The memory 212 includes a buffer 216 configured to store sensor measurements for the sensors 108. In particular, the buffer 216 may store a most recent (e.g., an updated) measurement detected at the respective sensor 108. In some examples, the buffer 216 may be partitioned into a raw buffer 220 and a filtered buffer 224. In particular, the raw buffer 220 may be configured to store respective sensor measurements from each sensor 108, while the filtered buffer 224 may store respective sensor measurements from a subset of the sensors 108. For example, the filtered buffer 224 may be configured based on buffering configuration data received from the server 112, as will be described further herein.

Thus, in accordance with the present disclosure, the controller 104 may obtain periodic updates from the sensors 108 and may update the respective sensor measurements in the buffer 216 accordingly. In such configurations, for a large set of sensors 108, the rate at which the controller 104 can obtain updated sensor data from each of the sensors 108 may be relatively slow (e.g., about 40 kHz to about 100 kHz). In contrast, the controller 104 may receive data requests from the server 112 at a different rate which may be faster than the rate at which the controller 104 obtains updates from the sensors 108. Thus, the controller 104 may store the most recent measurement detected at each of the sensors 108 in the buffer 216 for retrieval. Accordingly, upon receiving a data request from the server 112, rather than polling the sensors 108 (or a requested subset of the sensors 108), which may take time and cause delays in responding to the data request, the controller 104 may simply retrieve the buffered data representing the most recent measurements obtained from each of the sensors 108 from the buffer 216. The system 100 therefore better accommodates latency in the sensor data refresh rate without requiring expensive, complicated, and computationally complex mechanisms to improve the rate at which the controller 104 can obtain updated sensor data from the sensors 108.

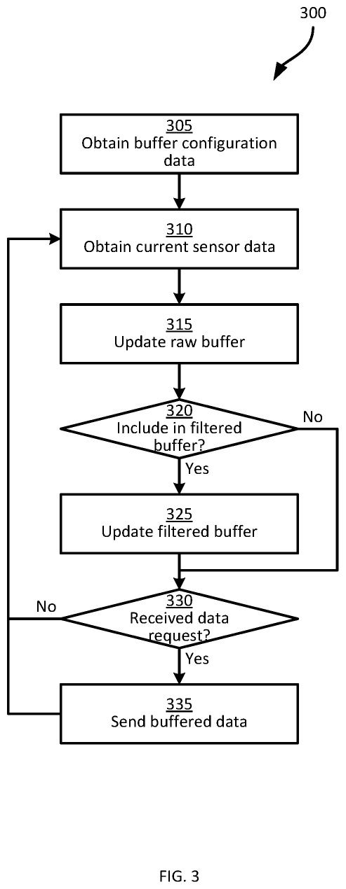

Turning now to FIG. 3, the functionality implemented by the system 100 will be discussed in greater detail. FIG. 3 illustrates a method 300 of buffering sensor data for responding to data requests. The method 300 will be discussed in conjunction with its performance in the system 100, and particularly by the controller 104. In particular, the method 300 will be described with reference to the components of FIGS. 1 and 2. In other examples, the method 300 may be performed by other suitable devices or systems.

The method 300 is initiated at block 305, where the controller 104 obtains buffer configuration data for configuring the buffer 216. More particularly, the buffer configuration data may define criteria for storing the respective sensor data (i.e., the buffered data) of the subset of the sensors 108 in the filtered buffer 224. For example, the buffer configuration data may identify a subset of the sensors 108 for which to filter sensor data to the filtered buffer 224. The buffer configuration data may be received, for example, from the server 112, and may correspond to an expected data request. That is, the server 112 may be configured for certain operations, and may request sensor data from a subset of sensors 108 to be used in said operations. Accordingly, the server 112 may specify the subset of sensors 108 in the buffer configuration data to filter the sensor data from the subset into the filtered buffer 224.

In other examples, the controller 104 may follow predefined default buffer configuration data. For example, the predefined default buffer configuration data may define a default subset of sensors 108 for which sensor data is to be filtered to the filtered buffer 224. Alternately, the buffer configuration data may define criteria under which the sensor data is to be filtered to the filtered buffer 224, such as when the change in sensor data is more than a threshold amount (e.g., when current sensor data detected by the sensor 108 differs by more than 5%, 10%, etc. relative to the previously stored sensor data in the buffer 216). In other examples, other buffer configurations and/or criteria which may be defined by the buffer configuration data are also contemplated.

In some examples, in response to obtaining the buffer configuration data, the controller 104 may partition the buffer 216 to define the raw buffer 220 and the filtered buffer 224. That is, the controller 104 may designate a portion of the buffer 216 to store respective sensor data from each sensor 108 in the set, and a portion of the buffer 216 to store the respective sensor data from a subset of the sensors 108. In particular, the size of the filtered buffer 224 may vary based on the subset and/or criteria defined in the buffer configuration data.

At block 310, the controller 104 obtains current sensor data from one of the sensors 108. In particular, the current sensor data may represent a most recent measurement detected at the sensor 108. In some examples, the controller 104 may actively poll the sensors 108 (i.e., the controller 104 may actively request the sensor data from each of the sensors 108). Since the controller 104 may operate using I2C communications, the polling operation of each of the sensors 108 may be serial or sequential, rather than parallel. Further, in some examples, the controller 104 may actively poll a subset of the sensors 108, for example based on instructions and/or an expected data request from the server 112.

In other examples, rather than polling the sensors 108, the controller 104 may receive the sensor data from one of the sensors 108, as initiated by the sensor 108. For example, the sensors 108 may be configured in a continuous mode, such that the sensors 108 are configured to send the sensor data to the controller 104 continuously, or at periodic predefined intervals. In other examples, the sensor 108 may be configured to send the sensor data upon detecting a change in the sensor data (e.g., above at least a threshold percentage from a previous measurement). Some or all of the sensor data transmission may be managed by a paired microcontroller for the sensor 108. For example, the paired microcontroller may further be configured to buffer the most recent sensor measurement until the sensor measurement can be sent to the controller 104, or to compare the current sensor data to the previous sensor data to determine whether or not to send the current sensor data.

At block 315, in response to obtaining the sensor data, the controller 104 is configured to update the buffer 216, and in particular, the raw buffer 220. That is, the controller 104 may replace the sensor data in the raw buffer 220 for the given sensor 108 with the current sensor data obtained at block 310 for the given sensor 108. That is, the raw buffer 220 may be updated with the current sensor data from each of the sensors 108, irrespective of the buffer configuration data or any expected data request from the server 112. Accordingly, the raw buffer 220 may represent the most recent measurements obtained from each of the sensors 108 in the set.

In some examples, prior to updating the buffer 216, the controller 104 may compare the current sensor data obtained at block 310 with previously stored sensor data for the sensor 108 (i.e., the sensor data stored in the buffer 216) to detect certain trigger conditions. For example, the trigger condition may include the current sensor data and the previously stored sensor data differing by above a threshold percentage or a threshold value. Such a difference may represent, for example, a certain action occurring in the environment in which the system 100 is deployed. For example, a reduction in the distance detected by one or more adjacent sensors 108 may represent placement of one of the items 116 on the shelf 120. Similarly, an increase in the distance detected by one or more adjacent sensors 108 may represent removal or displacement of one of the items 116 from the shelf 120. In some examples, the removal or displacement of an item 116 may trigger the controller 104 to send a notification to the server 112, to a mobile device of an operator of the system 100, or a suitable client device or the like.

At block 320, the controller 104 determines whether the current sensor data obtained at block 310 is designated for inclusion in the filtered buffer 224. For example, the controller 104 may make the determination based on the buffer configuration data obtained at block 305. That is, the controller 104 may determine whether the sensor 108 from which the current sensor data was received is designated in the buffer configuration data, and/or based on an evaluation of the current sensor data itself (e.g., based on a comparison between the sensor data and previously stored sensor data).

If the determination at block 320 is affirmative, that is, the controller 104 determines that the sensor data is to be included in the filtered buffer 224, then the controller 104 proceeds to block 325. At block 325, the controller 104 updates the buffer 216, and in particular, the filtered buffer 224. If the filtered buffer 224 contains sensor data for the given sensor 108, then the controller 104 may replace the previous sensor data with the sensor data obtained at block 310. If the filtered buffer 224 does not yet contain sensor data for the given sensor 108, then the controller 104 may simply add the sensor data to the filtered buffer 224 in association with the sensor 108. Accordingly, the filtered buffer 224 may represent the most recent measurements obtained from sensors 108 expected to be queried by the server 112 for a further processing operation.

If the determination at block 320 is negative, that is, the controller 104 determines that the sensor data is not to be included in the filtered buffer 224, or after performance of block 325, then the controller 104 proceeds to block 330. In particular, at any point while obtaining sensor data and managing the buffer 216, the controller 104 may receive a data request from the server 112. Accordingly, at block 330, the controller 104 determines whether a data request has been received from the server 112.

If the determination at block 330 is affirmative, that is, a data request has been received from the server 112, then the controller 104 proceeds to block 335. At block 335, the controller 104 retrieves and sends the sensor data stored in the buffer 216 to the server in response to the data request.

In some examples, the data request may correspond to the buffer configuration data, and accordingly, the controller 104 may simply retrieve the data stored in the filtered buffer 224. In other examples, the data request may specify a particular subset of the sensors 108 for which sensor data is requested. Accordingly, the controller 104 may retrieve the sensor data associated with the particular subset of sensors 108 from the raw buffer 220. In still further examples, the data request simply be a generic request, and hence the controller 104 may retrieve and provide all the data in the raw buffer 220 and/or the buffer 216 to the server 112.

If the determination at block 330 is negative, that is, a data request has not been received from the server 112, and/or after completion of performance of block 335, the controller returns to block 310. That is, the controller 104 may continue to iteratively obtain sensor data and update the buffer 216 continually. For example, the controller 104 may actively continue to sequentially poll the sensors 108, or the controller 104 may simply wait for subsequent sensor data to be received from one of the sensors 108. In other examples, the controller 104 may receive the data request from the server 112 at any point during performance of blocks 310 to 325, and in some examples, the performance of blocks 330 and 335 may be performed substantially simultaneously or in parallel to the performance of blocks 310 to 325.

In particular, since the buffer 216 stores the most recent sensor data from each of the sensors 108, the controller 104 may respond to data requests from the server 112 or other computing devices promptly using the buffered sensor data. This may reduce the amount of time to respond to such data requests, rather than waiting to poll each of the sensors 108 and receive sensor data from each of the sensors 108 individually, and serially, in the case of I2C communications.

For example, on a first iteration, the buffer 216 may store buffered data including first sensor data from the sensors 108 in the set. In particular, the first sensor data may represent a most recent measurement detected at each of the sensors 108. Accordingly, in response to a first data request from the server 112, the controller 104 may send the buffered data including the first sensor data to the server 112. On a second iteration, the controller 104 may obtain updates (i.e., second sensor data) from one or more given sensors 108, and may update the buffered data accordingly. However, as the refresh rate of obtaining sensor data from the sensors 108 may be different from (e.g., slower than) the rate of data requests from the server 112, the controller 104 may receive a second data request prior to updating the buffered data for all of the sensors 108 in the set. Thus, in response to the second data request, the controller 104 may send the buffered data including the second sensor data from the one or more given sensors 108 from which the second sensor data was received, and the first sensor data for a remainder of the sensors 108.

The controller 104 may continue to iteratively obtain further sensor data detected at a further subset of sensors in the set, and update the buffered data to include the further sensor data. Additionally, the controller 104 may iteratively receive subsequent data requests and send the buffered data in response to the subsequent data requests. The buffered data may include any further sensor data obtained since a most recent data request, as well as previously buffered data which may have already been sent to the server 112 during the previous data request.

The server 112 may then be able to perform operations in substantially real-time, for example to generate planograms of the items 116 on the shelves 120, to notify operators of changes and/or other events detected by the sensors 108, and the like. In particular, the server 112 may operate based on the most recent measurements obtained from each of the sensors 108, as stored in the buffered data in the buffer 216.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A controller comprising:
a communications interface to communicate with a set of sensors;
a memory including a buffer to store buffered data;
wherein the controller is configured to:
receive, from a server, a first data request;
in response to the first data request, send to the server the buffered data in the buffer, the buffered data including first sensor data from the sensors in the set;
obtain, from at least one given sensor in the set, second sensor data detected at the least one given sensor in the set;
update the buffered data in the buffer to include the second sensor data for the at least one given sensor;
receive, from the server, a second data request; and
in response to the second data request, send to the server the buffered data in the buffer, the buffered data including the second sensor data for the at least one given sensor in the set and the first sensor data for a remainder of the sensors in the set.

2. The controller of claim 1, wherein the buffer comprises:
a raw buffer configured to store the buffered data for each sensor in the set; and
a filtered buffer configured to store the buffered data for a subset of the sensors in the set.

3. The controller of claim 2, wherein the controller is further configured to:
obtain buffer configuration data defining criteria for storing the buffered data of the subset of the sensors in the filtered buffer.

4. The controller of claim 3, wherein, to update the buffered data with the second sensor data, the controller is further configured to:
update the raw buffer with the second sensor data for the at least one given sensor in the set; and
when the second sensor data meets the criteria defined in the buffer configuration data, update the filtered buffer with the second sensor data for the at least one given sensor in the set.

5. The controller of claim 2, wherein, in response to the first data request and the second data request, the controller is configured to send the buffered data stored in the filtered buffer to the server.

6. The controller of claim 1, wherein, in response to the first data request and the second data request, the controller is configured to send a subset of the buffered data stored in the buffer to the server.

7. The controller of claim 1, wherein the controller is further configured to:
compare the second sensor data for the at least one given sensor in the set with the first sensor data stored in the buffer for the at least one given sensor to detect a trigger condition; and
when the trigger condition is detected, send a notification to a client device.

8. The controller of claim 1, wherein the controller is configured to iteratively (i) obtain further sensor data detected at further sensors in the set and update the buffered data in the buffer to include the further sensor data for the further sensors and (ii) receive subsequent data requests and send the buffered data in response to the subsequent data requests, the buffered data including the further sensor data.

9. The controller of claim 1, wherein the controller is configured to:
receive the first and second data requests from the server at a first rate; and
further update the buffered data in the buffer at a second rate, the second rate being different than the first rate.

10. The controller of claim 1, wherein the second sensor data comprises an updated measurement detected at the at least one given sensor in the set.

11. A method comprising:
storing buffered data in a buffer;
receiving, from a server, a first data request;
in response to the first data request, sending to the server, the buffered data in the buffer, the buffered data including first sensor data from a set of sensors;
obtaining, from at least one given sensor in the set, second sensor data detected at the at least one given sensor;
updating the buffered data in the buffer to include the second sensor data for the at least one given sensor;
receiving, from the server, a second data request; and
in response to the second data request, sending the buffered data to the server, the buffered data including the second sensor data for the at least one given sensor in the set and the first sensor data for a remainder of the sensors in the set.

12. The method of claim 11, wherein the buffer comprises:
a raw buffer configured to store the buffered data for each sensor in the set; and
a filtered buffer configured to store the buffered data for a subset of the sensors in the set.

13. The method of claim 12, further comprising:
obtaining buffer configuration data defining criteria for storing the buffered data of the subset of the sensors in the filtered buffer.

14. The method of claim 13, wherein updating the buffered data comprises:
updating the raw buffer with the second sensor data for the at least one given sensor in the set; and
when the second sensor data meets the criteria defined in the buffer configuration data, update the filtered buffer with the second sensor data for the at least one given sensor in the set.

15. The method of claim 12, wherein sending the buffered data in response to the first data request and the second data request comprises sending the buffered data stored in the filtered buffer to the server.

16. The method of claim 11, wherein sending the buffered data in response to the first data request and the second data request comprises sending a subset of the buffered data stored in the buffer to the server.

17. The method of claim 11, further comprising:
comparing the second sensor data for the at least one given sensor in the set with the first sensor data stored in the buffer for the at least one given sensor in the set to detect a trigger condition; and
when the trigger condition is detected, sending a notification to a client device.

18. The method of claim 11, further comprising iteratively:
(i) obtaining further sensor data detected at further sensors in the set and updating the buffered data in the buffer to include the further sensor data for the further sensors; and
(ii) receiving subsequent data requests and sending the buffered data in response to the subsequent data requests, the buffered data including the further sensor data.

19. The method of claim 11, further comprising:
receiving the first and second data requests from the server at a first rate; and
further updating the buffered data in the buffer at a second rate, the second rate being different than the first rate.

20. The method of claim 11, wherein the second sensor data comprises an updated measurement detected at the at least one given sensor in the set.
